(19) United States
(12) Patent Application Publication
(10) Pub. No.: US 2016/0249038 A1
(43) Pub. Date: Aug. 25, 2016

(54) METHOD AND APPARATUS FOR CAPTURING 360 DEGREE VIEWING IMAGES USING SPHERICAL CAMERA AND MOBILE PHONE

(71) Applicants: ABDELHAKIM ABDELQADER MOSLEH, Herndon, VA (US); MOHAMMED GHEYATH, DUBAI (AE)

(72) Inventors: ABDELHAKIM ABDELQADER MOSLEH, Herndon, VA (US); MOHAMMED GHEYATH, DUBAI (AE)

(21) Appl. No.: 15/047,382

(22) Filed: Feb. 18, 2016

Related U.S. Application Data
(60) Provisional application No. 62/119,364, filed on Feb. 23, 2015.

(51) Int. Cl. H04N 13/02; H04B 1/3827; G02B 7/10; H04W 4/00; H04N 5/232; H04N 7/18

(52) U.S. Cl. CPC H04N 13/0203; H04N 5/23238; H04N 7/185; G02B 7/10; H04W 4/008; H04B 1/3833

(57) ABSTRACT

One aspect of the present invention discloses an image capturing system able to capturing 3-dimensional 360 degree viewing (“3D/360”) images using a smart phone and a ball-shaped spherical camera. The smart phone includes a digital image processor (“DIP”) capable of processing audio and video (“AV”) information. The camera includes a set of surface-mount lenses evenly distributed over the surface of spherical shaped camera. The camera further includes lens motion controllers and image sensors which are used to sense images captured by the lenses. The lens motion controllers are configured to independently control lens position or orientation for each surface-mount lens. To process and display 3D/360 images, the camera transmits 3D/360 images related information to the smart phone via a communication network, such as Ethernet cable, wireless channel, cellular channel, and/or Bluetooth® wireless network.

### PRIORITY

This application claims the benefit of priority based upon U.S. Provisional Patent Application Ser. No. 62/119,364, filed on Feb. 23, 2015 in the name of Abdelhakim Abdelqader Mosleh, and having a title of “Spherical 360 degrees 3 dimensional digital camera with single lens control and mobile phone control,” hereby incorporated into the present application by reference.

### FIELD

The exemplary embodiment(s) of the present invention relates to telecommunications network. More specifically, the exemplary embodiment(s) of the present invention relates to digital image processing.

### BACKGROUND

With increasing network capacity capable of handling voluminous multimedia information in a high-speed communications network, high quality and high resolution images and/or videos for audio video (“AV”) data are in high demand. A conventional camera system capable of capturing and processing quality 3 dimensional (“3D”) and/or 360 degree viewable pictures/frames typically requires sophisticated optical lens or lenses as well as high-speed AV image computing resource. A drawback associated with a conventional high quality camera capable of taking 3D or 360 degree viewable pictures is that it is bulky, heavy, and difficult to operate. For example, a typical 3D/360 camera also known as an omnidirectional camera is relatively large and bulky that is difficult to integrate into a mobile phone.

Another common problem associated with a conventional 3D/360 camera is that it requires unique lenses and special imaging processing hardware to manipulate a continuous panoramic view. For example, captured 2-dimensional (“2D”) image does not provide the image data needed to produce a 3D model or image. In addition, simultaneous zooming and focusing each camera generally consume large amount of hardware resource.

### SUMMARY

The following summary illustrates a simplified version(s) of one or more aspects of present invention. The purpose of this summary is to present some concepts in a simplified description as more detailed description that will be presented later.

One embodiment of present invention discloses an image capturing system able to capturing 3-dimensional 360 degree viewing (“3D/360”) images using a smart phone and a ball-shaped spherical camera. The smart phone includes a digital image processor (“DIP”) capable of processing audio and video (“AV”) information. The camera includes a set of surface-mount lenses evenly distributed over the surface of spherical shaped camera. The camera further includes lens motion controllers and image sensors which are used to sense images captured by the lenses. The lens motion controllers are configured to independently control lens position or orientation for each surface-mount lens. To process and display 3D/360 images, the camera transmits 3D/360 images related information to the smart phone via a communication network, such as Ethernet cable, wireless channel, cellular channel, and/or Bluetooth® wireless network.

Additional features and benefits of the exemplary embodiment(s) of the present invention will become apparent from the detailed description, figures and claims set forth below.

### BRIEF DESCRIPTION OF THE DRAWINGS

The exemplary aspect(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating a communication network containing an image capturing system capable of capturing 3D/360 images using a spherical camera in accordance with one embodiment of the present invention;

FIG. 2 is a block diagram illustrating a spherical camera coupled to a portable device capable of capturing 3D/360 images using multiple surface-mount lenses in accordance with one embodiment of the present invention;

FIG. 3 is a logic block diagrams illustrating a process of handling various 3D/360 images captured by a set of lenses mounted on the surface of spherical camera in accordance with one embodiment of the present invention;

FIG. 4 is a physical diagram illustrating an exemplary spherical camera configured to assist a portable device to capture 3D/360 images in accordance with one embodiment of the present invention;

FIG. 5 is a physical block diagram illustrating a top view of spherical camera showing distribution of lenses with overlapping views in accordance with one embodiment of the present invention;

FIG. 6 is a block diagram illustrating a structure of spherical camera used in conjunction with a smart phone in accordance with one embodiment of the present invention;

FIG. 7 is a diagram illustrating an operation of capturing and processing captured images using spherical camera and a mobile phone in accordance with one embodiment of the present invention;

FIG. 8 is a logic diagram illustrating an image processing procedure capable of processing 3D/360 images captured by surface-mount lenses in accordance with one embodiment of the present invention;

FIG. 9 is a block diagram illustrating primary view captured by primary lens and surrounding lens views captured by the surrounding lenses in accordance with one embodiment of the present invention;

FIG. 10 is a physical block diagram illustrating a spherical camera showing distribution of primary and surrounding lenses in accordance with one embodiment of the present invention;

FIG. 11 is a diagram illustrating a configuration of image capturing system containing a mobile phone and a spherical camera in accordance with one embodiment of the present invention;

FIG. 12 is a block diagram illustrating a portable device having a digital processing system capable of processing 3D/360 images in accordance with one embodiment of the present invention;

FIG. 13 is a block diagram illustrating a process of handling captured images in accordance with one embodiment of the present invention; and

FIG. 14 is a flowchart illustrating a process of processing 3D/360 images using a spherical camera and a portable device in accordance with one embodiment of the present invention.

### DETAILED DESCRIPTION

Embodiments of the present invention are described herein in the context of methods and/or apparatus for providing 3D/360 degrees camera (“3DC”) system capable of capturing 3D/360 images using a spherical camera and a mobile phone.

The purpose of the following detailed description is to provide an understanding of one or more embodiments of the present invention. Those of ordinary skills in the art will realize that the following detailed description is illustrative only and is not intended to be in any way limiting. Other embodiments will readily suggest themselves to such skilled persons having the benefit of this disclosure and/or description.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application- and business-related constraints, and that these specific goals will vary from one implementation to another and from one developer to another. Moreover, it will be understood that such a development effort might be complex and time-consuming, but would nevertheless be a routine undertaking of engineering for those of ordinary skills in the art having the benefit of embodiment(s) of this disclosure.

Various embodiments of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method. The same reference indicators will be used throughout the drawings and the following detailed description to refer to the same or like parts.

The term “system” or “device” is used generically herein to describe any number of components, elements, sub-systems, devices, packet switch elements, packet switches, access switches, routers, networks, modems, base stations, eNB (eNodeB), computer and/or communication devices or mechanisms, or combinations of components thereof. The term “computer” includes a processor, memory, and buses capable of executing instruction wherein the computer refers to one or a cluster of computers, personal computers, workstations, mainframes, or combinations of computers thereof.

IP communication network, IP network, or communication network means any type of network having an access network that is able to transmit data in a form of packets or cells, such as ATM (Asynchronous Transfer Mode) type, on a transport medium, for example, the TCP/IP or UDP/IP type. ATM cells are the result of decomposition (or segmentation) of packets of data, IP type, and those packets (here IP packets) comprise an IP header, a header specific to the transport medium (for example UDP or TCP) and payload data. The IP network may also include a satellite network, a DVB-RCS (Digital Video Broadcasting-Return Channel System) network, providing Internet access via satellite, or an SDMB (Satellite Digital Multimedia Broadcast) network, a terrestrial network, a cable (xDSL) network or a mobile or cellular network (GPRS/EDGE, or UMTS (where applicable of the MBMS (Multimedia Broadcast/Multicast Services) type, or the evolution of the UMTS known as LTE (Long Term Evolution), or DVB-H (Digital Video Broadcasting-Handhelds)), or a hybrid (satellite and terrestrial) network.

One embodiment of the presently claimed invention discloses an image capturing system able to capturing 3D/360 images using a smart phone and a ball-shaped spherical camera. In one example, the image capturing system can also be referred to as a 3D/360 degree camera (“3DC”) system. The smart phone includes a digital image processor (“DIP”) capable of processing audio and video (“AV”) information. The camera includes a set of surface-mount lenses evenly distributed over the surface of spherical shaped camera. The camera further includes lens motion controllers and image sensors which are used to sense images captured by the lenses. The lens motion controllers are configured to independently control lens position or orientation for each surface-mount lens. To process and display 3D/360 images, the camera transmits 3D/360 images related information to the smart phone via a communication network, such as Ethernet cable, wireless channel, cellular channel, and/or Bluetooth® wireless network.

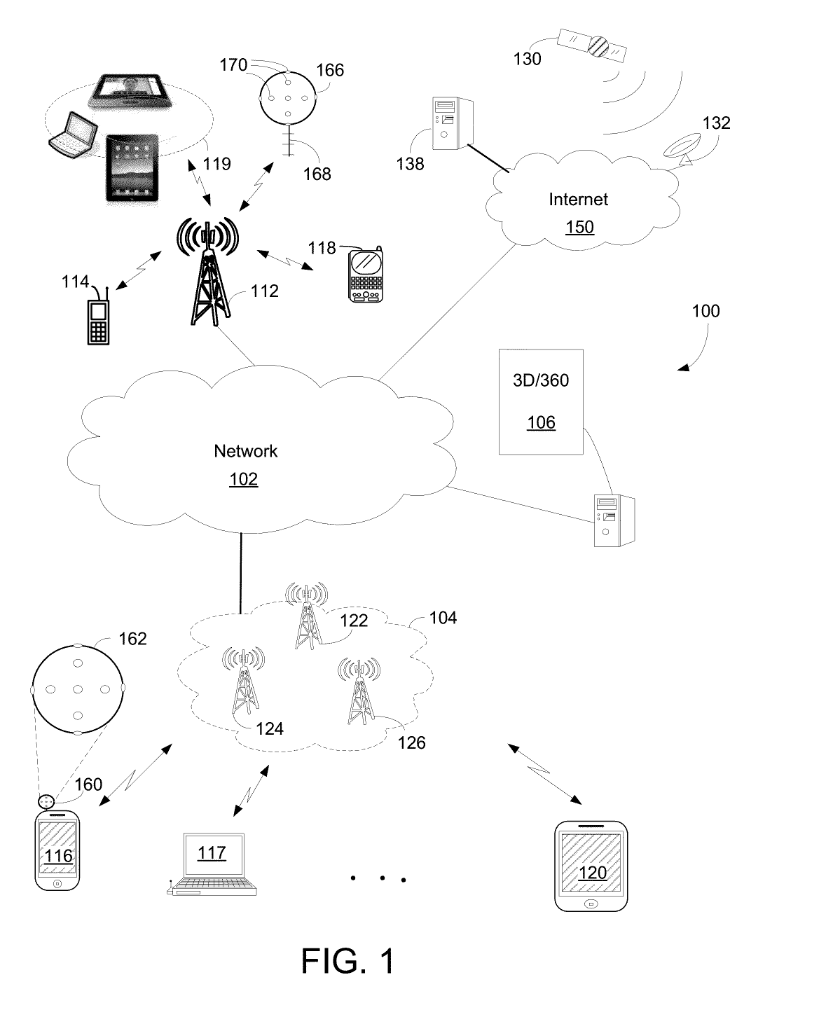

FIG. 1 is a block diagram illustrating a communication network containing an image capturing system capable of capturing 3D/360 images using a spherical camera in accordance with one embodiment of the present invention. Diagram 100 illustrates 3D/360 image capturing component 106, communication network 102, switching network 104, Internet 150, and portable electric devices 114-120. In one aspect, network 102 can be wide area network (“WAN”), metropolitan area network (“MAN”), local area network (“LAN”), satellite/terrestrial network, or a combination of WAN, MAN, and LAN. It should be noted that the underlying concept of the exemplary embodiment(s) of the present invention would not change if one or more blocks (or networks) were added to or removed from diagram 100.

Network 102 includes multiple network nodes, not shown in FIG. 1, wherein each node may include mobility management entity (“MME”), radio network controller (“RNC”), serving gateway (“S-GW”), packet data network gateway (“P-GW”), or HomeAgent to provide various network functions. Network 102 is coupled to Internet 150, my-status server 108, base station 112, and switching network 104. Server 108, in one embodiment, includes my-status management or my-status 106 which can be software, hardware, or combination of software and hardware component.

Switching network 104, which can be referred to as packet core network, includes cell sites 122-126 capable of providing radio access communication, such as 3G (3^{rd} generation), 4G, or 5G cellular networks. Switching network 104, in one example, includes IP and/or Multi Protocol Label Switching (“MPLS”) based network capable of operating at a layer of Open Systems Interconnection Basic Reference Model (“OSI model”) for information transfer between clients and network servers. In one embodiment, switching network 104 is logically coupling multiple PEDs 114-120 across a geographic area via cellular networks. It should be noted that the geographic area may refer to a campus, city, metropolitan area, country, continent, or the like.

Base station 112, also known as cell site, node B, or eNodeB, includes a radio tower capable of coupling to various user equipments (“UEs”), PEDs, or spherical camera 166. The term UEs and PEDs can be referred to similar portable devices and they can be used interchangeably. For example, UEs or PEDs can be cellular phone 114, handheld device 118, iPhone®116, tablets and/or iPad® 120 via wireless communications. Handheld device 118 can be a smart phone, such as iPhone®, BlackBerry®, Android®, Samsung Galaxy®, and so on. Base station 112, in one example, facilitates network communication between mobile devices such as portable handheld device 114-120 via wired and wireless communications networks. It should be noted that base station 112 may include additional radio towers as well as other land switching circuitry.

iPhone®116, in one embodiment, includes a spherical camera 160 capable of capturing 3D/360 panoramic pictures and/or videos. Spherical camera 160 as shown in an exploded view 162 includes multiple lenses mounted on the surface of spherical camera 160. In one aspect, lenses are evenly distributed on the surface of spherical camera 160 for capturing a 360-degree viewing image. Spherical camera 160, in one embodiment, is coupled to iPhone®116 via a wire, Bluetooth®, WiFi, cellular network, local wireless network, Ethernet, and the like.

Internet 150 is a computing network using Transmission Control Protocol/Internet Protocol (“TCP/IP”) to provide linkage between geographically separated devices for communication. Internet 150, in one example, couples to supplier server 138 and satellite network 130 via satellite receiver 132. Satellite network 130, in one example, can provide many functions as wireless communication as well as global positioning system (“GPS”). For example, my-status 106 can receive GPS information from satellite network 130 via Internet 150, network 102, and switching network 104.

Independent spherical camera (“ISC”) or spherical camera 166, in one embodiment, includes multiple lenses 170 and a transceiver 168 wherein transceiver 168 can be a wireless transceiver or land based transceiver. A function of ISC 166 is to capture 3D/360 image or images using one or more lenses 170. Upon capturing 3D/360 image information, it is transmitted to its destination via a communication network such as network 102. 3D/360 component 106, in one aspect, is coupled to a network such as network 102 to provide 3D/360 transmission services including distribution of network software for handling 3D/360 data. In one embodiment, 3D/360 component 106 resides at a server and provides 3D/360 image application (“App”) that can be installed or downloaded to portable phones.

During an exemplary operation, a user of portable device 119 downloads the App for 3D/360 component 106 via network 102. Upon installation of the App, device 119, in one embodiment, is able to communicate with ISC 166 and can request specific 3D/360 images or image information from ISC 166. Upon capturing the requested 3D/360 images, ISC 166 transmits imaging data to portable device 119 via network 102.

An advantage of employing spherical camera is to provide 3D/360 images using smart phone's computing capabilities.

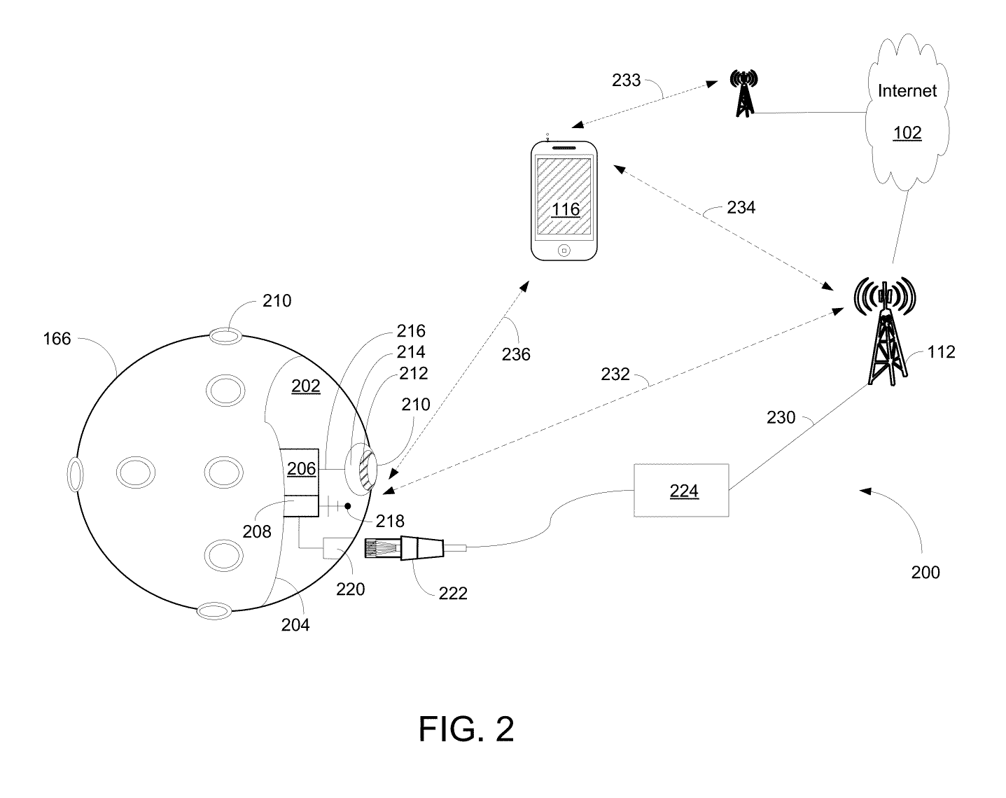

FIG. 2 is a block diagram 200 illustrating a spherical camera 166 coupled to a portable device 116 capable of capturing 3D/360 images using multiple surface-mount lenses in accordance with one embodiment of the present invention. Portable device 166 can be an iPhone®, smart phone, iPad®, Samsung Galaxy®, and/or laptop which is capable of connecting to spherical camera 166 via direct wireless channel 236, cellular channels 232-234, land line 230, and the like. It should be noted that the underlying concept of the exemplary embodiment(s) of the present invention would not change if one or more blocks (or networks) were added to or removed from diagram 200.

Diagram 200 illustrates spherical camera 166 with a portion of its spherical shaped camera 202 cut-open along line 204. Spherical camera 166, in one embodiment, includes multiple lenses 210 wherein each of multiple lenses 210 is supported by a lens motion controller 212 and an image sensor 214. To capture 3D/360 pictures and/or videos, a central processing unit (“CPU”) 206 is employed in spherical camera 166. While CPU 206 is coupled to every image sensor such as image sensor 214 via connection 216, CPU 206 is also coupled to a transceiver 208. Transceiver 208, in one example, is a combination of transmitter and receiver capable of performing transmission and receiving functions over a communications network. In one aspect, transceiver 208 can be integrated into CPU 206 as a single chip.

Transceiver 208, in one aspect, includes an antenna 218 and an Ethernet port 220 wherein port 220 can be used to receive an Ethernet plug 222 such as an RJ45 plug for coupling spherical camera 166 to a land line 230 via a local area network (“LAN”) 224. Antenna 218, in one example, can be used to communicate with wireless network(s) such as cellular network, Bluetooth, and/or WiFi network. It should be noted that WiFi can be a local area wireless computing network.

Diagram 200 illustrates a 3D/360 degree camera (“3DC”) system containing a smart phone 116 such as an iPhone®, spherical camera 166, and communication networks. Smart phone 116 includes a digital image processor (“DIP”) configured to process audio and video information. Spherical camera 166, in one embodiment, contains a set of surface-mount lenses 210 that are evenly distributed over the surface of spherical camera 166. Spherical camera 166, in one example, is configured to capture 3D/360 images. Spherical camera 166 further includes a group of image sensors such as sensor 212 and lens motion controllers such as controller 214.

The image sensors are coupled to surface-mount lenses 210 and are capable of sensing images, such as 3D, 360 degrees, or 3D/360 images or image information. The lens motion controllers are coupled to surface-mount lenses 210 and are configured to independently control lens position for each of surface-mount lenses 210. In one embodiment, spherical camera 166 has transceiver 208 able to transmit 3D/360 images or 3D/360 image information to smart phone 116 via a communication network. The communication network can be an Ethernet cable, wireless channel, cellular channel, Bluetooth® wireless network, or a combination of Ethernet, wireless channel, cellular channel, and Bluetooth® wireless network.

A function of 3DC system is able to capture 3D/360 images using a ball-shaped camera such as spherical camera 166 and a mobile phone such as iPhone® 116. The 3DC system which can also be referred to as image capturing system couples ball-shaped camera 166 to mobile phone 116 using one or more communication networks. In one example, the computing capability of mobile 116 is used to process 3D/360 images captured by the ball-shaped camera. With shifting a portion of image processing task from the camera to the mobile phone(s), the camera's functions and/or hardware is reduced whereby the overall size of spherical shaped camera is reduced. For instance, spherical camera may be fabricated with small and compact physical dimension(s) or attributes that can be easily integrated into or attached to a mobile phone.

In one example, a spherical, also known as 3D/360 degrees, camera is structured with a spherical round shape hosting a set of surface-mount lenses 210. Lenses 210, in one example, are covered or distributed evenly over the surface of spherical camera such as camera 166. Each lens of the surface-mount lenses 210 is attached to a motion controller such as controller 214 and an image sensor such as sensor 212. Motion controller 214 is connected to CPU 206 wherein CPU 206 controls movement of each lens to produce required zooming or focusing effect. An advantage of using surface-mount lenses is that the mounting method optimizes and/or minimizes overall size or dimension of the ball-shaped 3D/360 camera.

During an operation, at least a portion of multiple surface-mount lenses are instructed to take a picture with approximately simultaneous exposure. Multiple images associated with the picture are captured by the portion of multiple surface-mount lenses and a spherical distribution of viewing picture is generated using the multiple captured images. These images are subsequently processed using an image processor to produce one combined spherical image.

The 3DC system, in one embodiment, is able to control each surface-mount lens to determine whether it should be activated to take a picture. The 3DC system is configured to control zooming effect and/or orientation of each surface-mount lens for capturing a wider or narrower image(s). For example, lenses which are distributed around the middle of the sphere can be instructed to capture an image while other lenses are inactivated to obtain a 360-degree panoramic image but not a 3D image. An advantage of using a 3DC system is that it is able to capture a full 360-degree panoramic view. Another advantage of using a 3DC system is that it is capable of capturing full 360 degrees panoramic view in multiple directions spanning across the sphere shape to produce a full 360 degrees, 3D image of the captured scene.

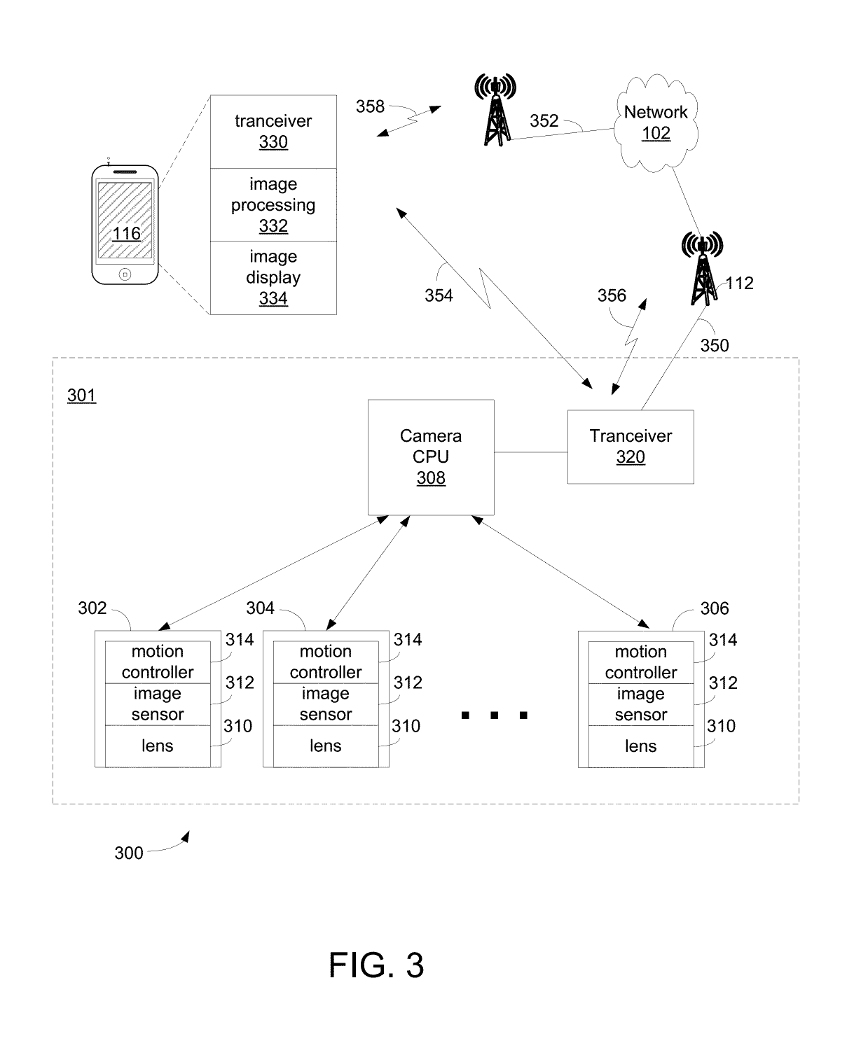

FIG. 3 is a logic block diagram 300 illustrating a process of 3DC system able to handle various 3D/360 images captured by a set of lenses mounted on the surface of spherical camera in accordance with one embodiment of the present invention. Diagram 300 includes a mobile 116, a spherical camera 301, and network 102 wherein spherical camera 301 is coupled to mobile 116 via network connections such as wireless channel 354 or network 102. It should be noted that the underlying concept of the exemplary embodiment(s) of the present invention would not change if one or more blocks (or networks) were added to or removed from diagram 300.

Spherical camera 301, in one embodiment, includes a camera CPU 308, transceiver 320, and a group of lens components 302-306. Each of lens components 302-306 includes a lens 310, image sensor 312, and motion controller 314. CPU 308 is configured to control each lens component based on instructions received from mobile 116 via transceiver 320. CPU 308 is also able to activate or deactivate selected lens components based on instructions and/or commands sent from mobile 116. Each motion controller 314 is controlled by CPU 308 to move or orient lens 310 for zooming or focusing effect. CPU 308 provides orientation and/or moving instruction to each lens component such as lens component 302 based on commands from mobile 116.

Transceiver 320 is used to communicate with transceiver 330 located at mobile 116 via wired or wireless communications networks. For example, transceiver 320 can communicate with transceiver 330 via WiFi network or Bluetooth network via channel 354. Alternatively, transceiver 320 may reach transceiver 330 via cellular network via channels 356-358. Also, transceiver 320 can couple to transceiver 322 via network 102 via channels 350-352 and radio towers 112. It should be noted that a wire or cable connection is also possible between transceivers 320-330.

Mobile 116, which can be a portable processing device and smart phone, includes transceiver 330, image processing 332, and image display 334. In one embodiment, mobile 116 is configured to include a DIP capable of performing image processing 332. In one aspect, DIP of mobile 116 is capable of instructing spherical camera 301 that the type of image(s) should be taken. Image display 334, for example, is able to display real-time images or videos captured by spherical camera 301 which could be placed miles away.

Diagram 300 illustrates a 3DC or image capturing system containing a portable processing device 116 and a camera 301. Portable processing device 116 includes a DIP configured to process AV information. In one example, portable processing device 116 is an iPhone®, iPad®, Samsung Galaxy®, or smartphone. In one aspect, portable processing device 116 includes an image displaying mechanism capable of displaying 3D/360 images and/or video.

Camera 301, in one embodiment, is structured with a spherical shape, and contains CPU 308, which is logically coupled to the DIP of portable processing device 116. Camera 301 is able to capture 3D/360 images. Camera 301, also known as spherical camera, includes a ball-shaped structure, lenses 310, and lens motion controllers 314. The ball-shape, round-shape, or elongated shape camera is configured to house CPU 308. Lenses 310 are physically mounted on the spherical surface of camera 301 capable of capturing images. Lens motion controllers 314 are coupled to lenses 310 and are configured to independently control the movement of each lens 310 that is amounted on the spherical surface of camera 301.

Camera 301 further includes various image sensors 312 coupled to lenses 310 wherein image sensors 312 are able to digitize various images captured by lenses 310. Image sensors 312, in one embodiment, generate or digitize sensed image information and subsequently forward sensed image information to CPU 308. In one example, image sensors 312 are charge-coupled devices (“CCDs”), also known as CCD image sensors. A function of a CCD is to visualize pixels collected in light of photons.

To communicate with portable processing device 116, camera 301 employs a transceiver which is able to transmit the sensed images to portable processing device 116 via a communication channel. The transceiver, in one embodiment, includes an antenna capable of communicating with regional base stations. The communication channel, in one example, can be an Ethernet cable, wireless channel, cellular channel, Bluetooth® wireless network, and the like.

In one embodiment, a portion of lenses 310 is categorized as primary lenses while the remaining portion of lenses 310 are considered as surrounding lenses 310. The lenses are designated as primary lenses are primarily based on their physical locations on the surface of spherical camera. For example, a spherical camera may contain 18 lenses wherein six (6) lenses are primary lenses while twelve (12) lenses are surrounding lenses.

An advantage of using a 3DC system with a spherical camera is that it allows control of each lens to define separate zooming effects and/or other types of control allowed by digital cameras. Note that the system allows taking simultaneous exposures of all lenses as well as separate or independent exposures to produce different types of images. Upon receiving multiple images for the same exposures, various images may be combined and manipulated while overlapping portions of images are separated and removed.

The 3DC system allows lenses to be mounted separately from the control mechanism and image sensor for reducing overall dimension of camera 301. Camera 301, in one example, is controlled by a mobile phone such as portable processing device 116. The camera, in one aspect, is mounted on top of a mobile phone. Alternatively, the camera can be remotely located and is connected to the mobile phone via a wireless signal. Note that single pixel manipulation within each image can be implemented. Also, pixel filter may be added to refine the captured images.

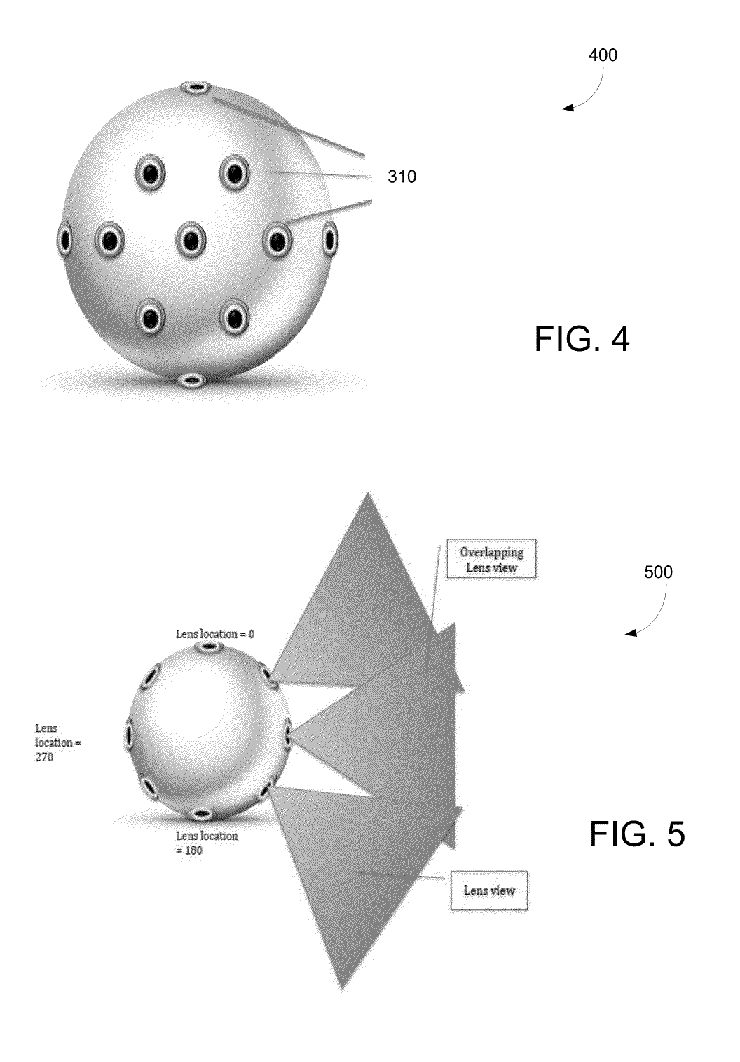

FIG. 4 is a physical diagram 400 illustrating an exemplary spherical camera configured to assist a portable device to capture 3D/360 images in accordance with one embodiment of the present invention. Diagram 400 illustrates a spherical shaped camera capable of housing multiple lenses 310 which are evenly distributed on the surface of camera in such a way that captures multiple zones of surroundings.

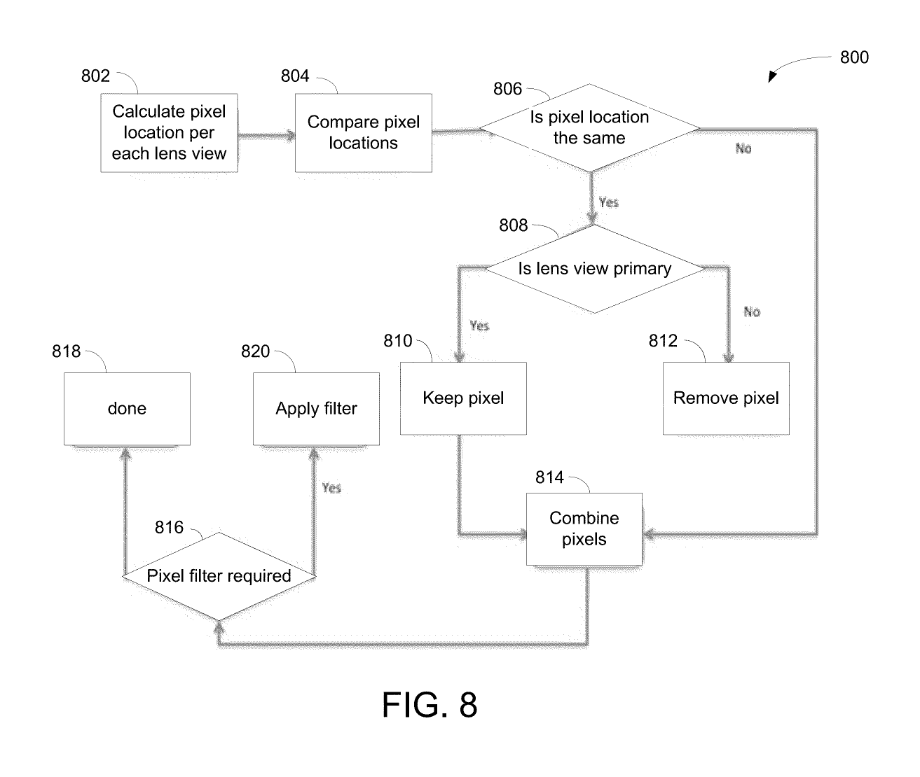

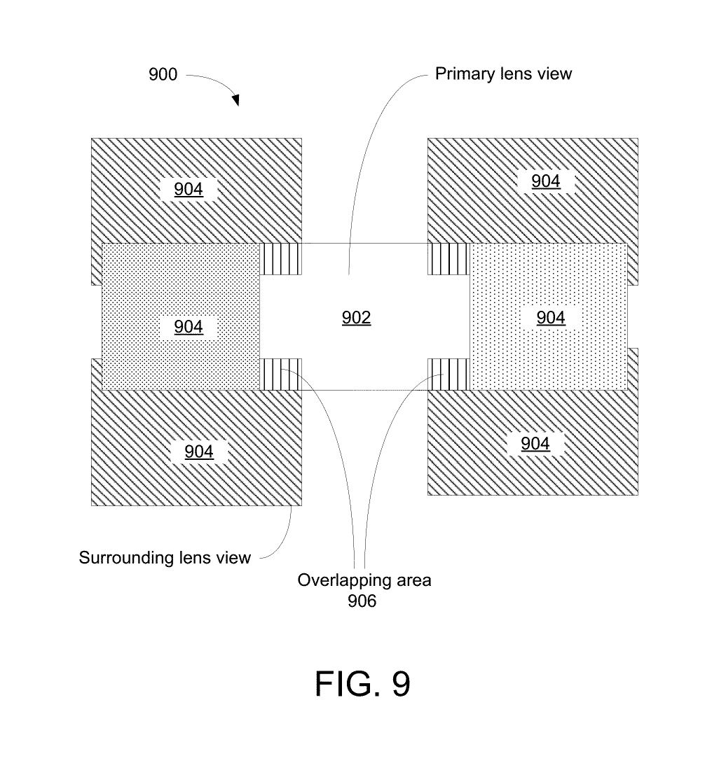

FIG. 5 is a physical block diagram 500 illustrating a view of spherical camera showing distribution of lenses with overlapping views in accordance with one embodiment of the present invention. Diagram 500 illustrates a distribution of lenses on the spherical surface of the camera to capture different zones including surrounding scene. It should be noted that a set of lenses distributed on the perimeter of the spherical surface can be repeated up and down on the spherical surface of camera. The distribution of lenses can generate overlaps between different images captured by different lenses. In one embodiment, an imaging processing to identify and remove overlapping portions of 3D/360 image will be described in FIGS. 8-9.

Each lens, in one aspect, can be controlled to define the exposure time and zooming effect separately or jointly with other lenses. Such control of each lens allows a user to define preferred image content. Also, such control of each lens allows a user to capture a specific image with one or more lenses. A user, in one example, uses 3DC system to handle or combine images captured in multiple ways with different effects by various lenses.

The camera or spherical camera, in one example, is controlled by a mobile phone or other mobile devices which communicate with the camera via a Bluetooth, WiFi, or other means of wired or wireless communication networks. An advantage of using a 3DC system with a spherical camera is that it enables a user to control lenses and lenses orientations to take user defined or preferred 3D, 360-degree, or 3D/360 images or videos.

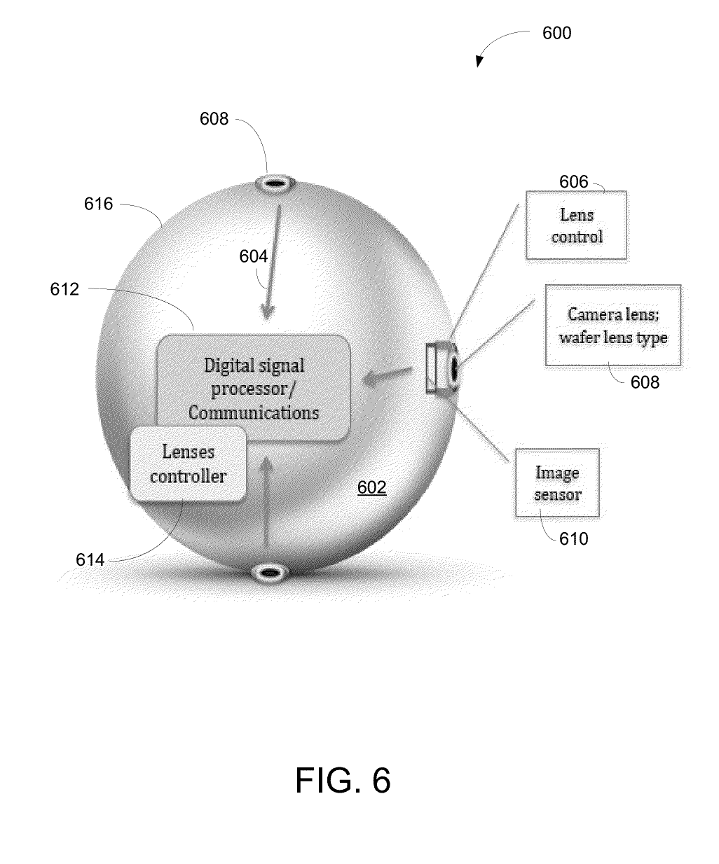

FIG. 6 is a block diagram 600 illustrating a structure of spherical camera 602 used in conjunction with a smart phone (not shown) to capture 3D/360 images in accordance with one embodiment of the present invention. Diagram 600 illustrates a spherical shaped camera 602 hosting multiple lenses 608 on surface 616 of the camera. Camera 602 is configured to house a digital signal processor 612 and a lenses controller 614. In one embodiment, camera 602 is structured in a compact size using semiconductor fabrication process and/or MEMS (microelectromechanical systems) fabrication process to assemble or process lenses 608 with image sensors 610 and lens control 606. It should be noted that the underlying concept of the exemplary embodiment(s) of the present invention would not change if one or more blocks (or components) were added to or removed from diagram 600.

To reduce overall size of a camera, various surface-mount lenses are used. Micro-machinery assembly such as MEMS assembly process may be used to manufacture spherical camera during an assembly of mobile phones. Depending on the applications, camera sizes can vary with different applications for multiple configurations. Lens control 606, which may be manufactured and attached with lens 608, includes lens movement part(s) which can be used to move lens 608 backwards and forward for zooming. Lenses 608 can also be moved up or down for providing adjustment(s) to picture or image(s) to be taken without movement of camera 602. Image sensor 610, in one embodiment, is an image capturing chip (or die or circuitry) which is connected to the image processor for imaging processing. In one embodiment, different types of lenses with different types of optical quality are used for enhancing image capturing. In one embodiment, multiple lenses are used to identify or measure distance. Alternatively, multiple lenses are used to identify or measure speed of a moving object such as a car or bird.

An advantage of having a compact camera is that it can be integrated into a smart phone.

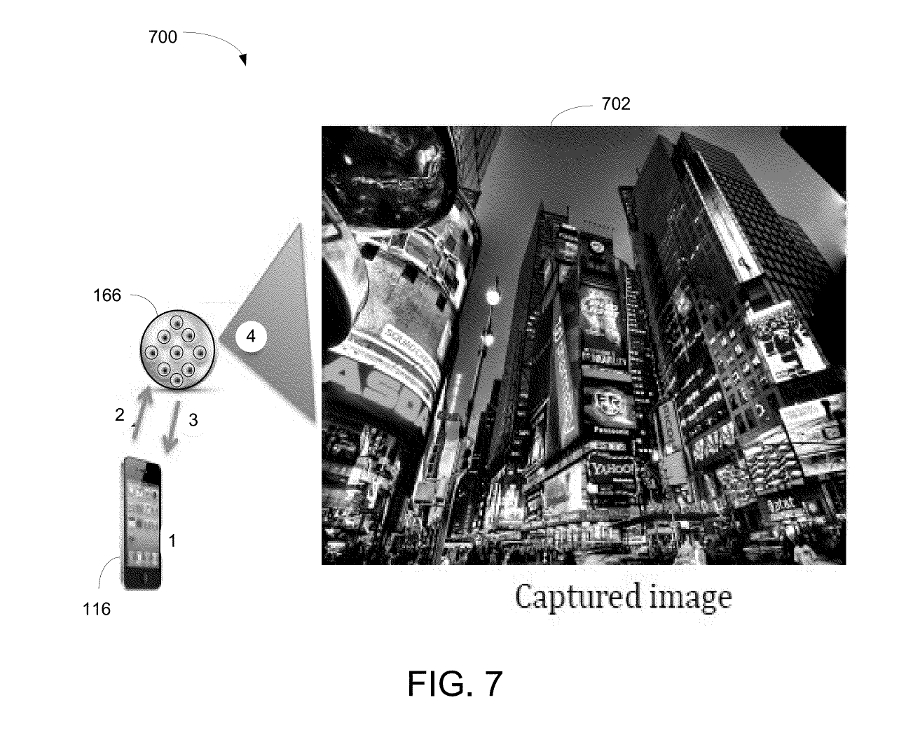

FIG. 7 is a diagram 700 illustrating an operation of capturing and processing captured images using spherical camera and a mobile phone in accordance with one embodiment of the present invention. During an operation, a user opens an application (“App”) on his or her mobile device 116 and subsequently could see at least a part of intended picture or video to be taken on the display as indicated by numeral 1. The user may choose either the picture or video. The App, in one example, is previously installed on mobile device 116. After the app sends a capture or record command to camera 166 via Bluetooth or GSM data link as indicated by numeral 2, camera 166 takes a 3D/360 panoramic picture or video 702 as indicated by numeral 4. Upon capturing the image information related to 3D, 360-degree, or 3D/360 image(s), the image information is transmitted back to mobile device 116 as indicated by numeral 3. Note that camera 166 can also transmit the image information to other different mobile devices concurrently. Upon receiving the image information by mobile device 116, the image information is processed by mobile device 116 to generate displayable 3D/360 image(s) and/or videos via the display of mobile device 116. It should be noted that the image information, in one aspect, is not displayable until the information is processed by mobile device 116.

To capture a full 360 degrees and/or 3D viewable image(s) with all directions, the distribution of lenses over the surface of camera and the image processing algorithm are important attributes to generate high quality/high resolution 3D/360 images or videos. Depending on the number of lenses, the image processing algorithm is used to calibrate and/or configure distribution of lenses to produce a complete or user defined 3D/360 picture or image.

FIG. 8 is a logic diagram illustrating an image processing procedure capable of processing 3D/360 images captured by surface-mount lenses in accordance with one embodiment of the present invention. In one embodiment, image processing algorithm is performed as follows:
The coordinate of lens location within the spherical shape is:

L(x,y,z)
where x,y,z are coordinates of lens location in x-axis, y-axis, and z-axis. Image for a
lens is identified as I(L), whereby,

Lens Location=L(x,y,z)
Image for this location is I(L)
Pixels map of an image is vector multiplication of actual pixel location within the
captured image as define in XY coordinate in the image and the corresponding lens
location can be identified as:

Pix(I)=[p(x,y)]X[L(x,y,z)]

The above equation gives a definition of every pixel location in terms of the lens location and the pixel location within an image frame. The algorithm then removes over lapping pixels by comparing this position of the pixel with similar pixel location from another image. The algorithm keeps one of the pixels in the final combined image. An exemplary process of implementing the algorithm is illustrated in logic diagram 800.

At block 802, the process calculates pixel location per each lens viewed or took the image. After comparing pixel locations associated with different images taken by different lenses at block 804, the process exams whether the pixel locations are the same at block 806. The process proceeds to block 814 to combine the pixels if the pixel locations are not the same at block 806. Otherwise, the process proceeds to block 808 to exam whether the lens view is primary. If the lens view is not primary, the process proceeds to block 812 to remove the pixel. If the lens view is primary at block 808, the process proceeds to block 810 to keep the pixel. After combining the pixels at block 814, the process proceeds to block 816 to determine whether the pixel filter is required. If the pixel filter is required, the process proceeds to block 820 to apply the filter. Otherwise, the process proceeds to block 818 to indicate that the process is done or terminated.

It should be noted that the algorithm of imaging process starts with comparing location of the pixels taken by one of the lenses with the surrounding lenses mage pixels.

FIG. 9 is a block diagram 900 illustrating primary view 902 captured by primary lens and surrounding lens views 904 captured by the surrounding lenses in accordance with one embodiment of the present invention. Diagram 900 illustrates one primary lens view 900 and six (6) surrounding lens views 904. The areas of overlapping between primary view 900 and surrounding lens views are overlapping areas 906. The algorithm starts with comparing location of the pixels taken by one of the lenses with the surrounding lenses mage pixels. The comparison of pixels is performed by a looping process which reiterates its process (or comparison) until all pixels are exhausted or depleted.

Same comparison is done for lenses. In every comparison, one lens is designated as primary and the other surrounding lenses are defined as secondary. If two pixels locations are similar when the comparison is done, the pixel from the primary is kept and the pixel from the secondary is removed.

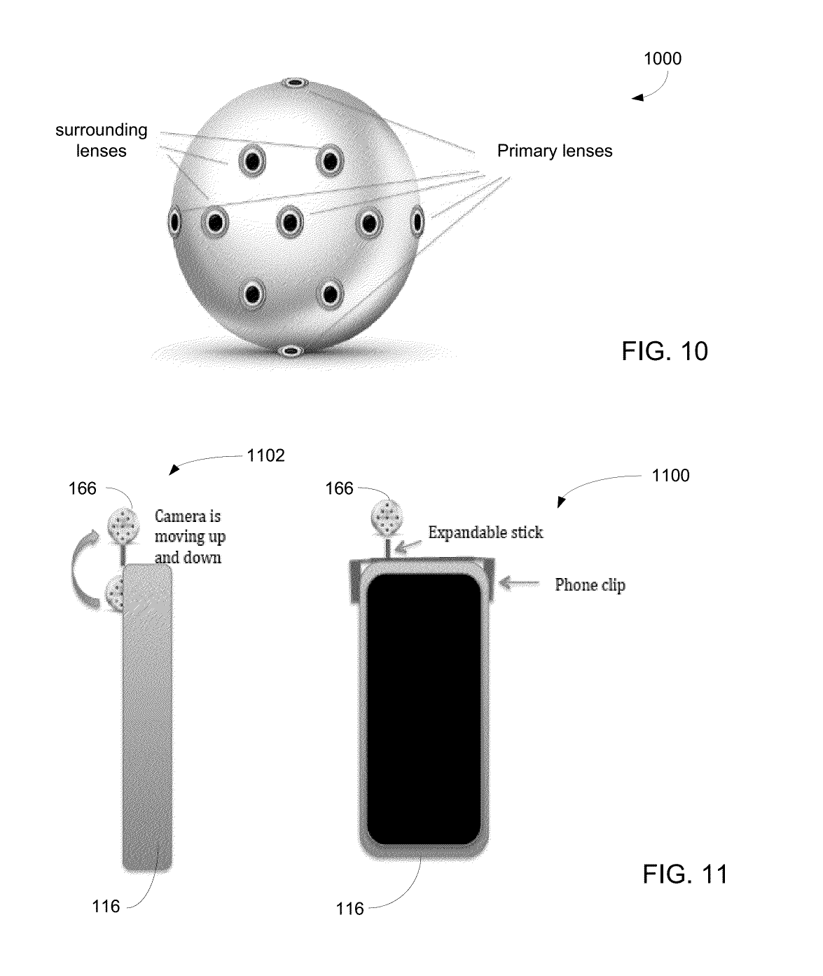

FIG. 10 is a physical block diagram illustrating a spherical camera 1000 showing distribution of primary and surrounding lenses in accordance with one embodiment of the present invention. In one example, camera 1000 has six (6) primary lenses and twelve (12) surrounding lenses. Depending on the applications, more or less primary or surrounding lenses may be configured and used.

Each of lens images after the comparison is kept and designated with its unique lens number. Once all comparisons are done, final combined image or spherical image the user sees is composed from all of these images or pixels. The final image can be described as the sum of all pixels as:

Final Pixel(x,y)=∫Pix(I)dx(I) where the limits of the integral is zero to total number of lenses used.

While the captured pixels are being calculated and compared pixels between multiple captured images, pixels can also be manipulated at the same time. For example, a filter may be added to the pixels. Another feature of controlling each lens is that it allows the user to control camera functions, such as shutting a single lens, grouping a cluster of lenses, forcing all lenses to capture images, zooming, and the like. The control within each lens is done by a program running on the mobile phone which is capable of displaying a map of each lens used in the camera. The user can define which lens to be used and which lens to be deactivated.

Once the App is selected then the program communicates with the control to define these settings and takes the picture. For example, when a picture is taken and processed according to the described algorithm, it is then returned back or communicated back to the phone where it can be viewed via viewer which is part of the mobile application. An advantage of using 3DC system is that it provides a true 3 dimensional and 360 degrees image capture using a configurable assembly which is fully controlled by a user and not fixed in its own assembly.

The image processing algorithm can produce both still images and video output. In one embodiment, the processes images frame by frame. By changing the processing power of the image processor, the quality of images is produced to be used with different type of mobile phones or as standalone camera.

FIG. 11 is a diagram 1100 illustrating a configuration of image capturing system containing a mobile phone and a spherical camera in accordance with one embodiment of the present invention. Diagram 1100 illustrates a mobile phone 116 having a spherical camera 166 with multiple surface-mount lenses placed on the surface of camera 166. Diagram 1102 illustrates a side view of mobile phone 116 shown in diagram 1100. In one embodiment, spherical camera 166 is attached to mobile phone 116 via an expandable stick. Alternatively, a phone clip is used to assist the movement of camera 166. Note that camera 166 can move up and down with respect to mobile phone 116.

The camera can be a companion used within current mobile phones as it uses surface mount lenses and their special configuration which allows it for a small dimension that can be integrated as part of the phone itself. Since camera 166 is fitted with wireless communication hardware and can be controlled remotely, it can be mounted within proximity of the user, or to be far from the user to take picture(s). The 3DC system further allows camera 166 to be attached to other types of remote configurations such as a quadruple flying machines or drone to take pictures.

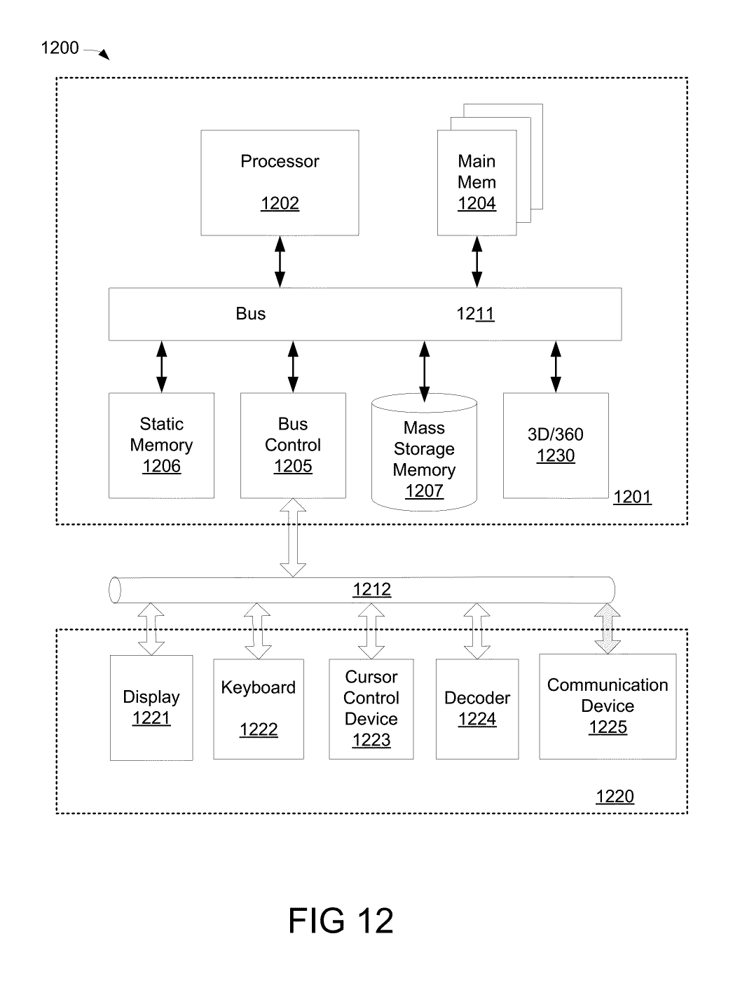

Having briefly described an aspect of 3DC system using a portable processing device and a camera, FIG. 12 illustrates an exemplary portable device or mobile phone having a digital processing system capable of processing 3D/360 images in accordance with one embodiment of the present invention. It will be apparent to those of ordinary skill in the art that other alternative network or system architectures may also be employed.

Computer system 1200, which can be applied to a mobile phone, includes a processing unit 1201, an interface bus 1212, and an input/output (“TO”) unit 1220. Processing unit 1201 includes a processor 1202, main memory 1204, system bus 1211, static memory device 1206, bus control unit 1205, and mass storage memory 1207. Bus 1211 is used to transmit information between various components and processor 1202 for data processing. Processor 1202 may be any of a wide variety of general-purpose processors, embedded processors, or microprocessors.

Main memory 1204, which may include multiple levels of cache memories, stores frequently used data and instructions. Main memory 1204 may be RAM (random access memory), MRAM (magnetic RAM), or flash memory. Static memory 1206 may be a ROM (read-only memory), which is coupled to bus 1211, for storing static information and/or instructions. Bus control unit 1205 is coupled to buses 1211-1212 and controls which component, such as main memory 1204 or processor 1202, can use the bus. Mass storage memory 1207 may be a magnetic disk, solid-state drive (“SSD”), optical disk, hard disk drive, floppy disk, CD-ROM, and/or flash memories for storing large amounts of data.

I/O unit 1220, in one example, includes a display 1221, keyboard 1222, cursor control device 1223, web browser 1224, and communication device 1225. Display device 1221 may be a liquid crystal device, flat panel monitor, cathode ray tube (“CRT”), touch-screen display, or other suitable display device. Display 1221 projects or displays graphical images or windows. Keyboard 1222 can be a conventional alphanumeric input device for communicating information between computer system 1200 and computer operator(s). Another type of user input device is cursor control device 1223, such as a mouse, touch mouse, trackball, or other type of cursor for communicating information between system 1200 and user(s).

Communication device 1225 is coupled to bus 1211 for accessing information from remote computers or servers through wide-area network. Communication device 1225 may include a modem, a router, or a network interface device, or other similar devices that facilitate communication between computer 1200 and the network. In one aspect, communication device 1225 is configured to perform wireless functions.

3D/360 imaging processor 1230, in one aspect, is coupled to bus 1211 within processing unit 1201. In one example, 3D/360 imaging processor 1230 is configured to processing 3D/360 image information and generates 3D/360 images and videos based on the sensed information. 3D/360 imaging processor 1230 can be operated in hardware, software, firmware, or a combination of hardware, software, and firmware.

The exemplary aspect of the present invention includes various processing steps, which will be described below. The steps of the embodiment may be embodied in machine or computer executable instructions. The instructions can be used to cause a general purpose or special purpose system, which is programmed with the instructions, to perform the steps of the exemplary aspect of the present invention. Alternatively, the steps of the exemplary embodiment of the present invention may be performed by specific hardware components that contain hard-wired logic for performing the steps, or by any combination of programmed computer components and custom hardware components.

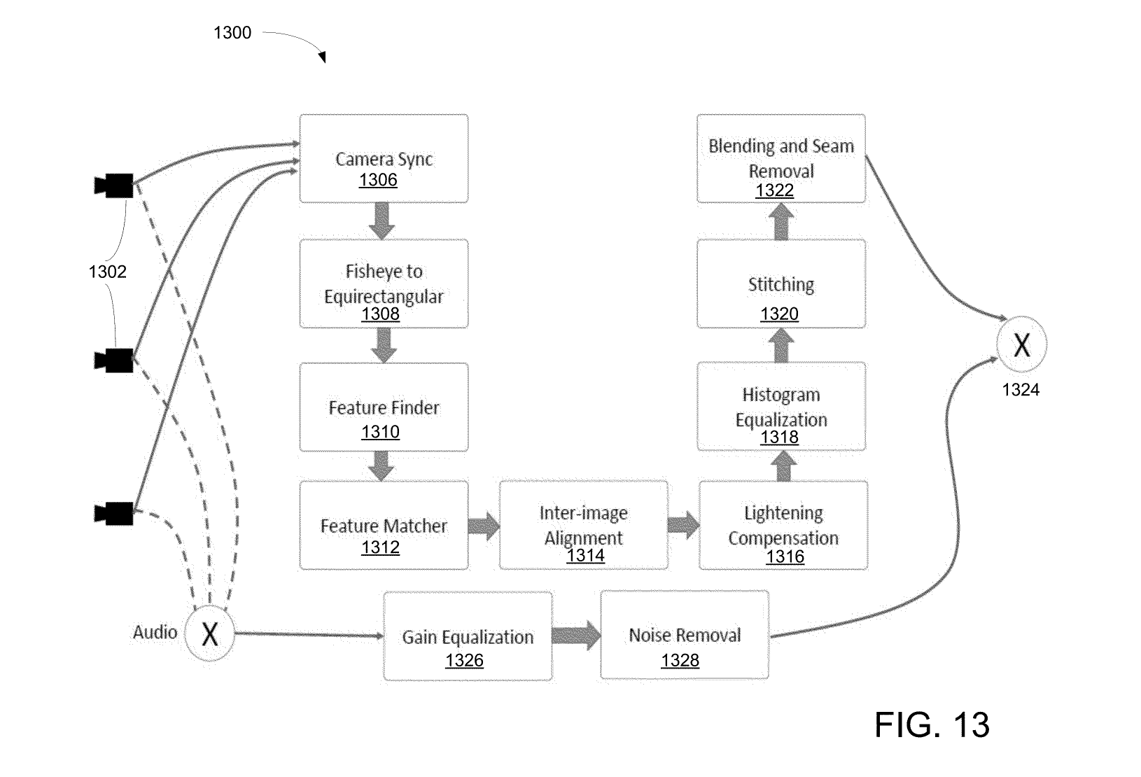

FIG. 13 is a block diagram 1300 illustrating a process of handling captured images in accordance with one embodiment of the present invention. Diagram 1300 illustrates multiple cameras 1302 using multiple surface-mount lenses to capture images as well as audio or voice. Upon synchronizing multiple cameras at block 1306, 3D/360 images generated in fisheye format is adjusted to form equirectangular format at block 1308. Upon finding the 3D/360 views via feature finder at block 1310, features are matched by a matcher at block 1312. Upon inter-image alignment at block 1314, the images or pixels are compensated by a lightening compensation process at block 1316. After applying histogram equalization to the captured images at block 1318, the pixels or images are at least partially stitched at block 1320. Once the images or pixels are blended, seamed, or removed at block 1322, the image(s) is forwarded to display 1324 for projecting 3D/360 image on a screen. If cameras 1302 record audio information, the audio information is forward to gain equalization component to process audio information at block 1326. After removing noise from the audio information at block 1328, the audio or voice data is forwarded to display 1324 to play audible sound based on the audio data.

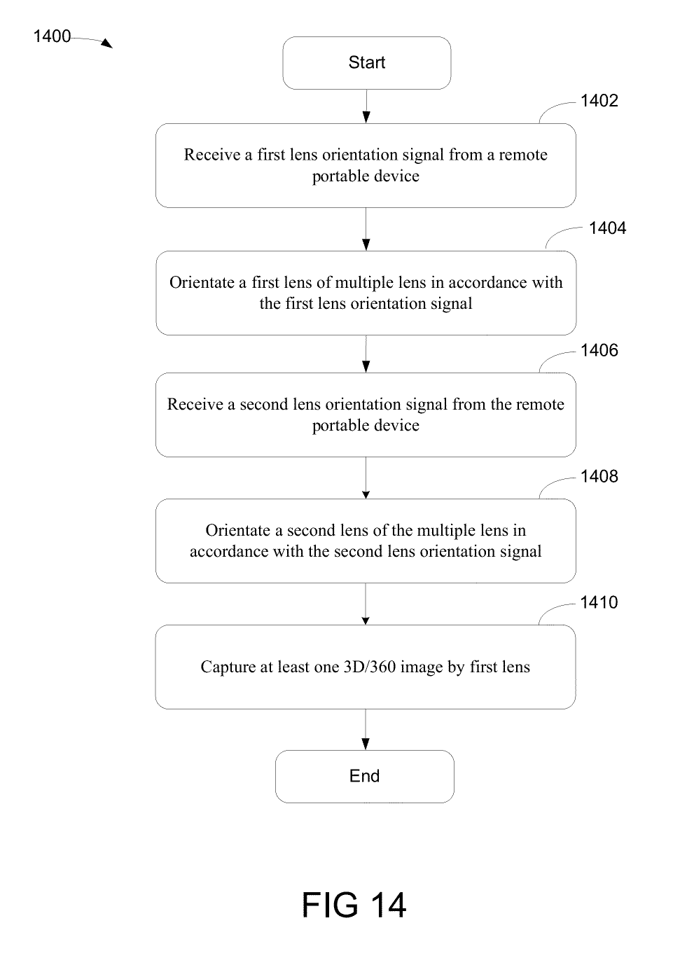

FIG. 14 is a flowchart 1400 illustrating a process of processing 3D/360 images using a spherical camera and a portable device in accordance with one embodiment of the present invention. At block 1402, a process capable of capturing 3D/360 viewing image(s) receives a first lens orientation signal from a remote portable device such as a mobile phone via a communication network. At block 1404, the first lens of multiple lenses mounted on a spherical surface of a camera is orientated in a first direction in accordance with the first lens orientation signal. After receiving a second lens orientation signal from the remote portable device via the communication network at block 1406, the second lens of the multiple lenses mounted on the spherical surface of the camera, at block 1408, is orientated in a second direction in accordance with the second lens orientation signal. At block 1410, at least one 3D/360 image is captured by the first lens.

While particular embodiments of the present invention have been shown and described, it will be obvious to those skilled in the art that, based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. An image capturing system comprising:
a portable processing device having a digital image processor (“DIP”) and configured to process audio and video (“AV”) information; and
a spherical shaped camera, containing a central processing unit (“CPU”), coupled to the DIP of the portable processing device and configured to capture 3-dimensional 360 degree viewing (“3D/360”) images, wherein the spherical shaped camera includes,
a ball-shaped structure having a spherical surface and configured to house the CPU;
a plurality of lenses physically mounted on the spherical surface and capable of capturing images;
a plurality of lens motion controllers coupled to the plurality of lenses and configured to independently control movement of each lens amounted on the spherical surface.

2. The system of claim 1, further comprising a plurality of image sensors coupled to the plurality of lenses and able to digitize various images captured by the plurality of plurality of lenses.

3. The system of claim 2, wherein the plurality of image sensors is configured to generate sensed images and forwards the sensed images to the CPU.

4. The system of claim 3, wherein the CPU, coupled to a transceiver, is able to transmit the sensed images to the portable processing device via a communication channel.

5. The system of claim 4, wherein the communication channel is one of an Ethernet cable, wireless channel, cellular channel, and Bluetooth® wireless network.

6. The system of claim 1, wherein the portable processing device is an iPhone®.

7. The system of claim 1, wherein the portable processing device is a smartphone.

8. The system of claim 1, wherein the portable processing device includes an image displaying mechanism.

9. The system of claim 1, wherein the camera includes a transceiver capable of communicating with the portable processing device via a communications network.

10. The system of claim 1, wherein the camera includes an antenna able to communicate with nearby base station.

11. The system of claim 1, wherein the plurality of lenses includes a set of primary lenses and a set of surrounding lenses.

12. The system of claim 11, wherein the plurality of lenses includes six (6) primary lenses and twelve (12) surrounding lenses.

13. The system of claim 1, wherein the plurality of lens motion controllers controls zooming of the plurality of lenses.

14. The system of claim 1, wherein the plurality of lens motion controllers controls lenses orientations associated with the plurality of lenses.

15. A method of capturing 360 degree viewing images, comprising:
receiving a first lens orientation signal from a remote portable device via a communication network;
orientating a first lens of multiple lenses mounted on a spherical surface of a camera in a first direction in accordance with the first lens orientation signal;
receiving a second lens orientation signal from the remote portable device via the communication network;
orientating a second lens of the multiple lenses mounted on the spherical surface of the camera in a second direction in accordance with the second lens orientation signal; and
capturing at least one 3-dimensional (“3D”) 360 degree viewing (“3D/360”) image by the first lens.

16. The method of claim 15, further comprising capturing a plurality of 3D/360 images by a plurality of image sensors coupled to the multiple lenses.

17. The method of claim 16, further comprising collecting the plurality of 3D/360 images at a central processing unit (“CPU”) situated in a spherical camera.

18. The method of claim 17, further comprising forwarding the plurality of 3D/360 images from the CPU of the spherical camera to the remote portable device.

19. An image capturing system comprising:
a smart phone, having a digital image processor (“DIP”), configured to process audio and video (“AV) information; and
a spherical camera, containing a plurality of surface-mount lenses approximately evenly distributed over surface of the spherical camera, coupled to the smart phone and configured to capture 3-dimensional (“3D”) 360 degree viewing (“3D/360”) images, wherein the spherical camera includes,
a plurality of image sensors coupled to the plurality of surface-mount lenses and capable of sensing images;
a plurality of lens motion controllers coupled to the plurality of surface-mount lenses and configured to independently control lens position for each of the plurality of surface-mount lenses.

20. The system of claim 19, wherein the spherical camera has a transceiver able to transmit the 3D/360 images to the smart phone via a communication network which is one of an Ethernet cable, wireless channel, cellular channel, and Bluetooth® wireless network.
